(19) United States
(12) Patent Application Publication
(10) Pub. No.: US 2011/0085522 A1
(43) Pub. Date: Apr. 14, 2011

(54) METHOD FOR ALLOCATING SLOTS FOR EMERGENCY DATA AND METHOD FOR TRANSMITTING EMERGENCY DATA USING THE SAME

(75) Inventors: Hyung Il Park, Daejeon (KR); Young Mi Kwon, Daejeon (KR); Jung Hwan Hwang, Daejeon (KR); Sung Weon Kang, Daejeon (KR)

(73) Assignees: Electronics and Telecommunications Research Institute, Daejeon (KR); The Industry & Academic Cooperation in Chungnam National University (IAC), Daejeon (KR)

(21) Appl. No.: 12/902,113

(22) Filed: Oct. 11, 2010

(30) Foreign Application Priority Data
Oct. 13, 2009 (KR) 10-2009-0097277
Apr. 19, 2010 (KR) 10-2010-0035889

(51) Int. Cl. H04J 3/00

(52) U.S. Cl. 370/336

(57) ABSTRACT

There are provided a method for allocating slots for emergency data and a method for transmitting emergency data using the same. The method for allocating slots for emergency data may be configured to include: allocating slots for emergency data to superframes that are configured to include a beacon period indicating a start of the superframe, a contention access period (CAP) transmitting data through contention, and a contention free period (CFP) transmitting data without contention; and providing slot allocating information on the emergency data to nodes. As a result, the method for allocating slots for emergency data allocates the separate slots for the emergency data while avoiding the contention access period (CAP) frequently used, which are used in the inter-node contention mode to enable the plurality of nodes to use one slot for one emergency data. In particular, even though there may be the risk of transmission failure due to the contention mode, the occurrence frequency of the emergency message, or the like, is low, which results in a similar effect to allocating the dedicated slots for the emergency data to the plurality of nodes while avoiding the transmission failure.

### CROSS-REFERENCE TO RELATED APPLICATIONS

This application claims the priority of Korean Patent Application No. 10-2009-0097277 filed on Oct. 13, 2009 and No. 10-2010-0035889 filed on Apr. 19, 2010, in the Korean intellectual Property Office, the disclosure of which is incorporated herein by reference.

### BACKGROUND OF THE INVENTION

1. Field of the Invention

The present invention relates to a method for allocating slots for emergency data and a method for transmitting emergency data using the same, and more particularly, a method for locating slots for emergency data and a method for transmitting emergency data using the same capable of securing the transmission of emergency data.

2. Description of the Related Art

in a beacon-enabled mode based on the existing IEEE 802.15.4 standard, an example of types of time slots allocated to superframes may include a contention access period (CAP) that is a contention mode and a contention free period (CFP) that is a non-contention mode, or the like.

In existing superframe architecture, when nodes transmit emergency message or data by using the contention access period, the transmission frequency of various kinds of data (channel allocation requests and the like) generated in the contention access period is increased, such that it is more likely to fail in transmitting the emergency message or data when the nodes transmit the emergency message or data, which results in a limitation in transmitting the emergency message or data while meeting requirements of the IEEE 802.15.6 WBAN standard defined to allow the plurality of nodes to transmit the emergency message or data within 1 sec.

Further, considering the case in which the contention free period is used, there is a problem in allocating time slots to the plurality of nodes by the non-contention mode due to the limitation of the number of guaranteed time slots (GTSs) located to the contention free period.

Therefore, a method capable of allocating the guaranteed time slots in the contention free period to the plurality of nodes while reducing the risk of transmission failure involved in transmitting the emergency message or data has been required in the IEEE 802.15. 6 WBAN standard.

### SUMMARY OF THE INVENTION

An aspect of the present invention provides a method for allocating slots for emergency data capable of guaranteeing transmission of emergency data.

Another aspect of the present invention provides a method for transmitting emergency data using a method for allocating slots for emergency data capable of guaranteeing transmission of emergency data.

According to an aspect of the present invention, there is provided a method for allocating slots for emergency data, including: allocating slots for emergency data to superframes that are configured to include a beacon period indicating a start of the superframe, a contention access period (CAP) transmitting data through contention, and a contention free period (CFP) transmitting data without contention; and providing slot allocating information on the emergency data to nodes.

The allocating of the slots for emergency data may be performed by a request of the nodes.

The slots for emergency data are allocated in the contention free period (CFP).

The slots for emergency data may be allocated in the active period configuring the contention free period (CFP).

The slots for emergency data may be used in a method for transmitting data to the contending nodes.

The slots for emergency data may be used in the nodes using a carrier sense multiple access with collision avoidance (CSMA/CA) method.

The slots for emergency data may be allocated in plural.

Only one of the plurality of slots for emergency data may be allocated to each of the plurality of superframes.

According to another aspect of the present invention, there is provided a method for transmitting emergency data, comprising: receiving slot allocating information on the emergency data in superframes, which are configured to include a beacon period indicating the start of the superframe, a contention access period (CAP) transmitting data through contention, and a contention free period (CFP) transmitting data without contention, from a coordinator; and when the emergency data are generated, transmitting the emergency data to the coordinator by using the slots for emergency data according to the slot allocating information on the emergency data.

The method for transmitting emergency data may further include requesting slot allocation for emergency data in the superframe.

The slots for emergency data may be allocated in the contention free period (CFP).

The slots for emergency data may be allocated in the active period configuring the contention free period (CFP).

The slots for emergency data may be allocated in plural.

Only one of the plurality of slots for emergency data may be allocated to each of the plurality of superframes. At least one of the plurality of slots for emergency data may be allocated to one of the plurality of superframes.

The transmitting of the emergency data to the coordinator may be used in a method for transmitting data through contention.

The transmitting of the emergency data to a coordinator may be used in the nodes using a carrier sense multiple access with collision avoidance (CSMA/CA) method.

The method for transmitting emergency data may further include retransmitting the emergency data to the coordinator in the case that the transmission of the emergency data fails.

The retransmitting of the emergency data to the coordinator may use the slots for emergency data to retransmit the emergency data.

The retransmitting of the emergency data to the coordinator may use the contention access period (CAP) to transmit the emergency data.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flow chart explaining a method for allocating slots for emergency data according to an exemplary embodiment of the present invention;

FIGS. 2A and 2B are exemplified diagrams explaining the method for allocating slots for emergency data according to an exemplary embodiment of the present invention; and

FIG. 3 is a flow chart explaining a method for transmitting emergency data using the method for allocating slots for emergency data according to an exemplary embodiment of the present invention.

### DETAILED DESCRIPTION OF THE PREFERRED EMBODIMENT

Although the present invention can be modified variously and have several embodiments, the exemplary embodiments are illustrated in the accompanying drawings and will be described in detail in the detailed description.

However, the present invention is not limited to the specific embodiments and should be construed as including all the changes, equivalents, and substitutions included in the spirit and scope of the present invention.

Further, terms used in the specification, ‘first’, ‘second’, etc. can be used to describe various components, but the components are not to be construed as being limited to the terms. The terms are only used to differentiate one component from other components. For example, the first component may be called the second component without departing from the scope of the present invention. Likewise, the second component may be called the first component. The term ‘and/or’ includes a combination of a plurality of items or any one of a plurality of terms.

in the case it is stated that any components are “connected” or “coupled” to other components, it is to be understood that the components may be directly connected or coupled to other components, but there is another component therebetween. On the other hand, in the case that it is stated that any components are “directly connected” or “directly coupled” to other components, it is to be understood that there is no another component therebetween.

The terms used in the specification are used to describe only specific embodiments and are not intended to limit the present invention. Singular forms are intended to include plural forms unless the context clearly indicates otherwise. it will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Unless indicated otherwise, it is to be understood that all the terms used in the specification including technical and scientific terms has the same meaning as those that are understood by those who skilled in the art. It must be understood that the terms defined by the dictionary are identical with the meanings within the context of the related art, and they should not be ideally or excessively formally defined unless the context clearly dictates otherwise.

Hereinafter, exemplary embodiments of the present invention will be described in detail with reference to the accompanying drawings. In describing the present invention, similar components are denoted by similar reference numerals in order to help in an overall understanding of the present invention and descriptions of the same or similar components will not be repeated.

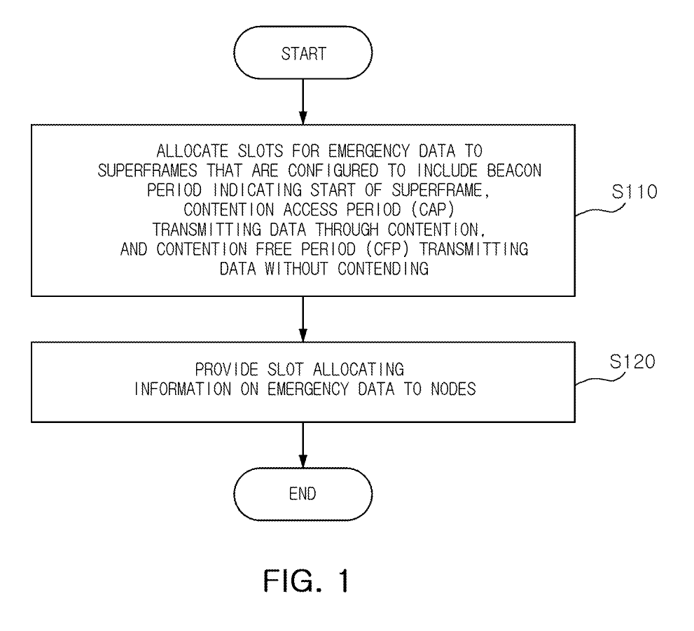

FIG. 1 is a flow chart explaining a method for allocating slots for emergency data according to an exemplary embodiment of the present invention.

Referring to FIG. 1, a method for allocating slots for emergency data according to an exemplary embodiment of the present invention may be configured to include allocating slots for emergency data to superframes (S110) and providing slot allocating information on the emergency data to nodes (S120), wherein the superframe is configured to include a beacon period indicating a start of the superframe, a contention access period (CAP) transmitting data through contention, and a contention free period (CFP) transmitting data without contention.

The method for allocating slots for emergency data according to an exemplary embodiment of the present invention is a method for allocating slots for emergency data from a coordinator's standpoint.

First, the allocating of the slots for emergency data to the superframes (S110) may correspond to allocating slots for transmitting emergency data to nodes in the superframe when the emergency data are generated.

Further, the allocating of the slots for emergency data to the superframes (S110) may be performed by the coordinator and may be performed by the request of the nodes.

Herein, the slots for emergency data may be allocated in the contention free period (CFP), not the contention access period (CAP). In particular, the slots for emergency data may be allocated in an active period in the contention free period (CFP).

Further, the slots for emergency data may be used in the method for transmitting data to the contending nodes. In other words, even though the slots for emergency data are allocated in the contention free period (CFP), not the contention access period (CAP), the emergency data may be transmitted by all the contending nodes in the slots for emergency data so that all the plurality of nodes can be used.

Further, the contending nodes may transmit the emergency data through the slots for emergency data by using a carrier sense multiple access with collision avoidance (CSMA/CA) method that is one of several known methods for transmitting emergency data.

Further, the slot for emergency data may be allocated in plural. Further, only one slot of the plurality of slots for emergency data may be allocated to each of the plurality of superframes.

In other words, the plurality of slots for emergency data may be allocated by the request of the nodes or the coordinator. In the case of using the plurality of superframes to which the plurality of slots for emergency data, one slot for emergency data is allocated to one superframe, such that it is possible to effectively guarantee the transmission of general data.

This is to minimize the transmission loss of general data by reducing the slots capable of transmitting the general data when the plurality of slots for emergency data exist in one superframe.

Next, the providing of the slot allocating information on the emergency data to the nodes (S120) may use the slot allocating information on the emergency data in order to transmit the emergency data generated when the emergency situations occur in the nodes to the coordinator.

For example, it is recognized by the slot allocating information on the emergency data that a first slot of the contention free period (CFP) is a slot allocated for emergency data. Further, when the emergency situations occur, the emergency data are generated to notify the emergency situations and the generated emergency data may be transmitted to the coordinator by using the first slot of the contention free period (CFP) in the superframe.

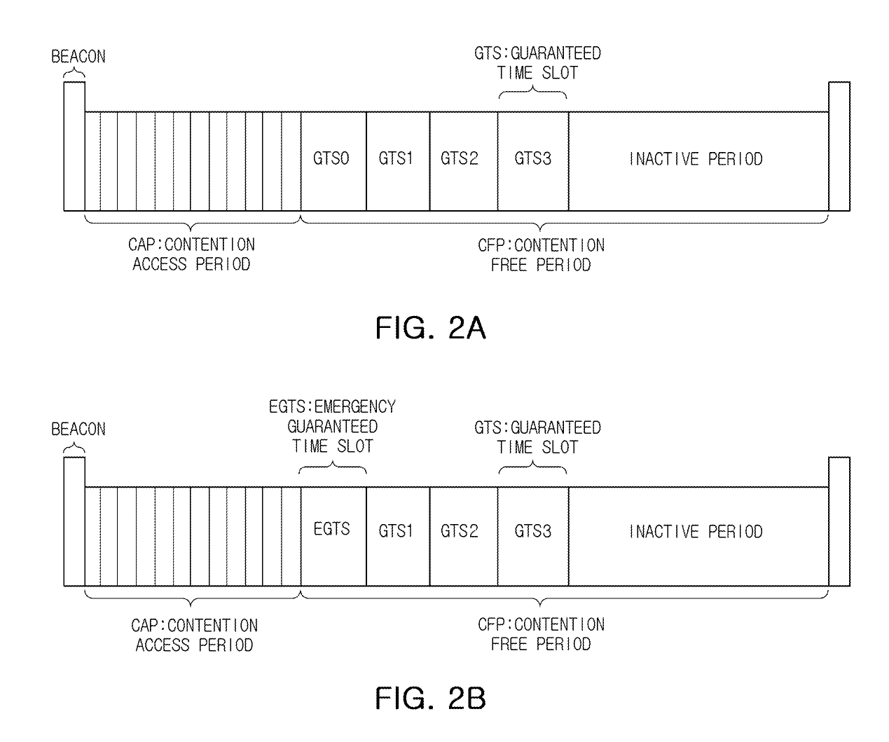

FIGS. 2A and 2B are exemplified diagrams explaining the method for allocating slots for emergency data according to an exemplary embodiment of the present invention.

FIG. 2A shows general superframe architecture.

The superframe may be configured to include a beacon period indicating the start of the superframe, the contention access period (CAP) transmitting data through contention, and a contention free period (CFP) transmitting data without contention.

Further, the contention free period (CFP) transmitting data without contention may be classified into an active period and an inactive period.

In particular, the nodes are contention in the contention access period (CAP) to transmit data and to retransmit the corresponding data when the transmission of data fails.

Meanwhile, the dedicated period may be allocated to each node in the active period of the contention free period (CFP), thereby making it possible to stably transmit data without the risk of the transmission failure.

FIG. 2B shows the superframe architecture when the slots for emergency data are allocated.

When the slots for emergency data are allocated to the superframe, the slots for emergency data may be allocated to any positions in the superframe, for example, to the contention free period (CFP), in particular, the active period of the contention free period (CFP).

Therefore, the emergency data may be transmitted in the state where the transmission failure is prevented.

Meanwhile, the plurality of nodes may be used in the method for transmitting data among the plurality of contending nodes so that they can use the slots for emergency data.

The reason is that the occurrence frequency of the emergency data is low and thus, the probability of transmission failure is low, even though the method for transmitting data by the plurality of contending nodes uses the slots for emergency data.

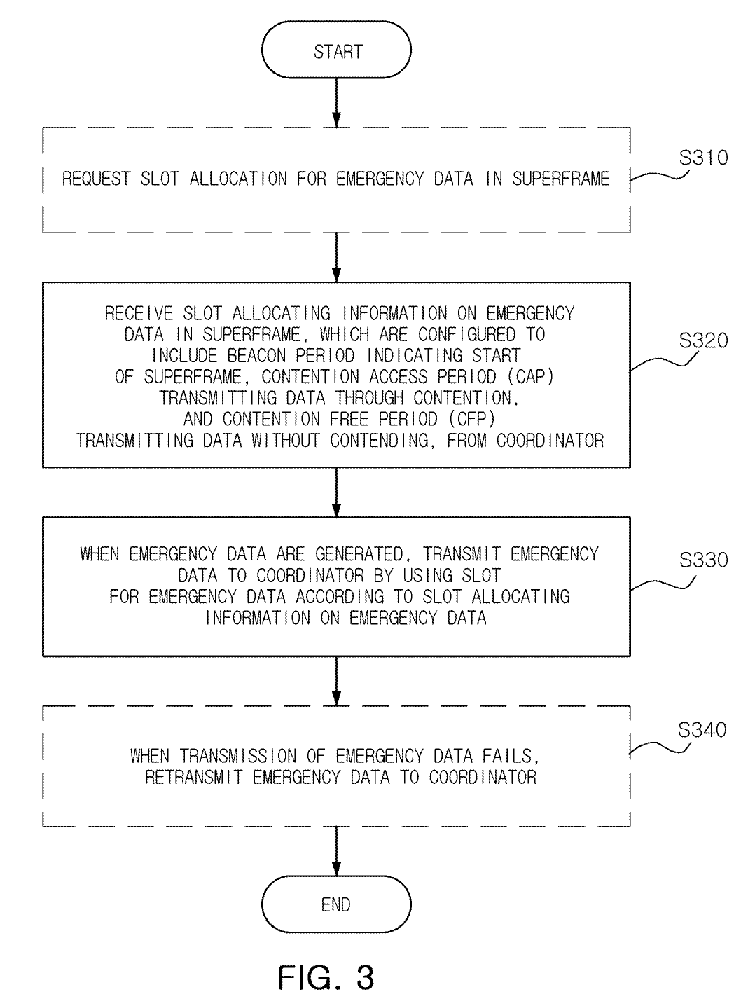

FIG. 3 is a flow chart explaining a method for transmitting emergency data using the method for allocating slots for emergency data according to an exemplary embodiment of the present invention.

Referring to FIG. 3, the method for transmitting emergency data using the method for allocating the slots for emergency data according to an exemplary embodiment of the present invention may be configured to include receiving the slot allocating information on emergency data in superframes from the coordinator (S320) and when the emergency data are generated, transmitting the emergency data to the coordinator by using the slots for emergency data according to the slot allocating information on the emergency data (S330), wherein the superframe is configured to include a beacon period indicating the start of the superframe, a contention access period (CAP) transmitting data through contention, and a contention free period (CFP) transmitting data without contention.

The method for transmitting emergency data using the method for allocating the slots for emergency data according to an exemplary embodiment of the present invention is described from the node's standpoint.

First, prior to the step of receiving the slot allocating information on the emergency data in the superframe from the coordinator (S320), the method for transmitting the emergency data may further include requesting the slot allocation for emergency data in the superframe (S310).

In other words, when the node wants to transmit the emergency data but the dedicated slots for emergency data are not yet allocated, the method for transmitting the emergency data may request that the coordinator requests slot allocation for emergency data.

Meanwhile, the superframe may be configured to include a beacon period indicating the start of the superframe, the contention access period (CAP) transmitting data through contention, and a contention free period (CFP) transmitting data without contention.

Next, the receiving of the slot allocating information on the emergency data in the superframe from the coordinator (S320) may correspond to receiving the slot allocating information on the emergency data by the requesting of the slot allocating for emergency data in the superframe (S310) or by the coordinator.

In other words, the nodes can transmit the emergency data by using the corresponding slots by receiving the slot allocating information on emergency data in the superframe when the emergency data are generated.

The slots for emergency data may be allocated in the contention free period (CFP). In particular, the slots for emergency data may be allocated in the active period of the active period and the inactive period configuring the contention free period.

In addition, the slots for emergency data may be allocated in plural. Only one slot of the plurality of slots for emergency data may be allocated to each of the plurality of superframes. At least one of the plurality of slots for emergency data may be allocated to one of the plurality of superframes.

In other words, since one slot for emergency data is allocated to one superframe, the effect on the transmission of general data can be minimized.

Next, the transmitting of the emergency data to the coordinator (S330) may correspond to transmitting the emergency data using the slots for emergency data according to the slot allocating information on the emergency data when the emergency data are generated.

The transmitting of the emergency data to the coordinator (S330) may be used in the method for transmitting data through contention. In other words, the transmitting of the emergency data to the coordinator may be used in the nodes by using a carrier sense multiple access with collision avoidance (CSMA/CA) method.

In other words, although the slots for the emergency data are allocated in the contention free period (CFP), the operational mode of the slots for emergency data is performed so that all the nodes uses the dedicated slots for emergency data through the contention mode, thereby providing the equivalent use authority to all the nodes.

In addition, in the case that the transmission of the emergency data fails, the method for transmitting the emergency data may include retransmitting the emergency data to the coordinator (S340).

The retransmitting of the emergency data to the coordinator (S340) may correspond to retransmitting the emergency data by using the slots for emergency data and correspond to transmitting the emergency data by using the contention access period (CAP).

Consequently, the retransmitting of the emergency data to the coordinator (S340) can guarantee the predetermined level of transmission and retransmit the emergency data by retransmitting the emergency data using the slots for emergency data and perform the transmission using the contention access period (CAP) in order to more stably guarantee the transmission of the emergency data, which may be further generated, by processing the emergency data according to the method for processing the general data.

As set forth above, the method for allocating slots for emergency data and the method for transmitting emergency data using the same allocate the separate slots for the emergency data while avoiding the contention access period (CAP) frequently used, which are used in the inter-node contention mode to enable the plurality of nodes to use one slot for one emergency data. In particular, even though there may be the risk of transmission failure due to the contention mode, the occurrence frequency of the emergency message, or the like, is low, which results in a similar effect to allocating the dedicated slots for the emergency data to the plurality of nodes while avoiding the transmission failure.

While the present invention has been shown and described in connection with the exemplary embodiments, it will be apparent to those skilled in the art that modifications and variations can be made without departing from the spirit and scope of the invention as defined by the appended claims.

What is claimed is:

1. A method for allocating slots for emergency data, comprising:
allocating slots for emergency data to superframes that are configured to include a beacon period indicating a start of the superframe, a contention access period (CAP) transmitting data through contention, and a contention free period (CFP) transmitting data without contention; and
providing slot allocating information on the emergency data to nodes.

2. The method for allocating slots for emergency data of claim 1, wherein the slots for emergency data are allocated in the contention free period (CFP).

3. The method for allocating slots for emergency data of claim 2, wherein the slots for emergency data are allocated in the active period configuring the contention free period (CFP).

4. The method for allocating slots for emergency data of claim 2, wherein the slots for emergency data are used in a method for transmitting data to the contending nodes.

5. The method for allocating slots for emergency data of claim 4, wherein the slots for emergency data are used in the nodes using a carrier sense multiple access with collision avoidance (CSMA/CA) method.

6. The method for allocating slots for emergency data of claim 1, wherein the slots for emergency data are allocated in plural.

7. The method for allocating slots for emergency data of claim 6, wherein only one of the plurality of slots for emergency data is allocated to each of the plurality of superframes.

8. A method for transmitting emergency data, comprising:
receiving slot allocating information on the emergency data in superframes, which are configured to include a beacon period indicating the start of the superframe, a contention access period (CAP) transmitting data through contention, and a contention free period (CFP) transmitting data without contention, from a coordinator; and
when the emergency data are generated, transmitting the emergency data to the coordinator by using the slots for emergency data according to the slot allocating information on the emergency data.

9. The method for transmitting emergency data of claim 8, wherein the slots for emergency data are allocated in the contention free period (CFP).

10. The method for transmitting emergency data of claim 9, wherein the slots for emergency data are allocated in the active period configuring the contention free period (CFP).

11. The method for transmitting emergency data of claim 8, wherein the slots for emergency data are allocated in plural.

12. The method for transmitting emergency data of claim 11, wherein only one of the plurality of slots for emergency data is allocated to each of the plurality of superframes.

13. The method for transmitting emergency data of claim 11, wherein At least one of the plurality of slots for emergency data is allocated to one of the plurality of superframes.

14. The method for transmitting emergency data of claim 8, wherein the transmitting of the emergency data to the coordinator is used in a method for transmitting data through contention.

15. The method for transmitting emergency data of claim 14, wherein the transmitting of the emergency data to the coordinator is used in the nodes using a carrier sense multiple access with collision avoidance (CSMA/CA) method.

16. The method for transmitting emergency data of claim 8, further comprising retransmitting the emergency data to the coordinator in the case that the transmission of the emergency data fails.

17. The method for transmitting emergency data of claim 16, wherein the retransmitting of the emergency data to the coordinator uses the slots for emergency data to retransmit the emergency data.

18. The method for transmitting emergency data of claim 16, wherein the retransmitting of the emergency data to the coordinator uses the contention access period (CAP) to transmit the emergency data.
